(19) United States
(12) Patent Application Publication
(10) Pub. No.: US 2024/0410218 A1
(43) Pub. Date: Dec. 12, 2024

(54) DIRECT RF AUTHENTICATION FOR API ACCESS

(71) Applicant: Gentex Corporation, Zeeland, MI (US)

(72) Inventors: Eric P. Bigoness, Ada, MI (US); David J. Becksvoort, Grand Haven, MI (US)

(73) Assignee: Gentex Corporation, Zeeland, MI (US)

(21) Appl. No.: 18/739,442

(22) Filed: Jun. 11, 2024

Related U.S. Application Data
(60) Provisional application No. 63/472,399, filed on Jun. 12, 2023.

(51) Int. Cl. E05F 15/77; B60R 1/12; G08C 17/02; H04W 12/041; H04W 12/50

(52) U.S. Cl. CPC E05F 15/77; B60R 1/12; H04W 12/041; H04W 12/50; B60R 2001/1284; E05Y 2900/106; E05Y 2900/132; G08C 17/02

(57) ABSTRACT

A door operating system includes a door opening mechanism and a user controller including a first receiver configured to receive an RF signal and a second receiver configured to receive an internet signal. The user controller is in communication with the door opening mechanism and includes an RF transmitter capable of transmitting the RF signal to the door opening mechanism and a wireless internet transmitter capable of transmitting the internet signal to the door opening mechanism. The user controller includes a user interface including at least one user input element and is in operable communication with the door opening mechanism and the user controller. The control system is configured to generate and exchange a key during an initial pairing, receive an input from the user controller to open or close a door, and determine if the RF signal from the RF transmitter will be received by the door opening mechanism.

### CROSS-REFERENCE TO RELATED APPLICATION

This application claims priority to and the benefit under 35 U.S.C. § 119(e) of U.S. Provisional Application No. 63/472,399, filed on Jun. 12, 2023, entitled “DIRECT RF AUTHENTICATION FOR API ACCESS,” the disclosure of which is hereby incorporated herein by reference in its entirety.

### FIELD OF THE DISCLOSURE

The present disclosure generally relates to a door operating system, and, more particularly, to a door operating system for a vehicle that includes a dual authentication process.

### SUMMARY OF THE DISCLOSURE

According to one aspect of the present disclosure, a door operating system that moves a door between a closed position and an open position is provided. The door operating system includes a door opening mechanism and a user controller. The door opening mechanism includes a first receiver configured to receive an RF signal and a second receiver configured to receive an internet signal. The user controller is in operable communication with the door opening mechanism and includes an RF transmitter capable of transmitting the RF signal to the door opening mechanism and a wireless internet transmitter that is capable of transmitting the internet signal to the door opening mechanism. The user controller further includes a user interface including at least one user input element. A control system is in operable communication with the door opening mechanism and the user controller. The control system is configured to generate and exchange a key during an initial pairing, receive an input from the user controller to open or close a door, and determine if the RF signal from the RF transmitter will be received by the door opening mechanism.

According to another aspect of the present disclosure, a door operating system that moves a door between a closed position and an open position is provided. The door operating system includes a door opening mechanism and a user controller. The door opening mechanism includes a first receiver configured to receive a short range signal and a second receiver configured to receive an internet signal. A user controller is in operable communication with the door opening mechanism. The user controller includes a short range transmitter capable of transmitting the short range signal to the door opening mechanism, a wireless internet transmitter capable of transmitting the internet signal to the door opening mechanism, and a user interface including at least one user input element. A control system is in operable communication with the door opening mechanism and the user controller. The control system is configured to generate the short range signal and exchange a key during an initial pairing, generate the internet signal and transfer the key to an intermediary server, and selectively transmit at least one of the short range signal and the internet signal to move the door between the open position and the closed position.

According to yet another aspect of the present disclosure, a door operating system that moves a door between a closed position and an open position is provided. The door operating system includes a door opening mechanism and a user controller. The door opening mechanism includes a first receiver configured to receive a short range signal and a second receiver configured to receive an internet signal. A user controller is in operable communication with the door opening mechanism. The user controller includes a short range transmitter capable of transmitting the short range signal to the door opening mechanism, a wireless internet transmitter capable of transmitting the internet signal to the door opening mechanism, and a user interface including at least one user input element. A control system is in operable communication with the door opening mechanism and the user controller. The control system is configured to initially transmit the short range signal from the short range transmitter to the door opening mechanism, and determine if the short range signal from the short range transmitter has been or will be received by the door opening mechanism. If the short range signal has not been received by the door opening mechanism, the control system is further configured to transmit the internet signal from the wireless internet transmitter to the door opening mechanism.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an interior perspective view of a cabin in a vehicle with a mirror assembly, according to one aspect of the present disclosure;

FIG. 2 is a schematic view of a door operating system, according to one aspect of the present disclosure;

FIG. 3 is a schematic view of a control system of the mirror assembly, according to one aspect of the present disclosure; and

FIG. 4 is a method of utilizing a door operating system that includes a dual authentication process, according to one aspect of the present disclosure.

### DETAILED DESCRIPTION

The present illustrated embodiments reside primarily in combinations of method steps and apparatus components related to a door operating system for a vehicle that includes a dual authentication process. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

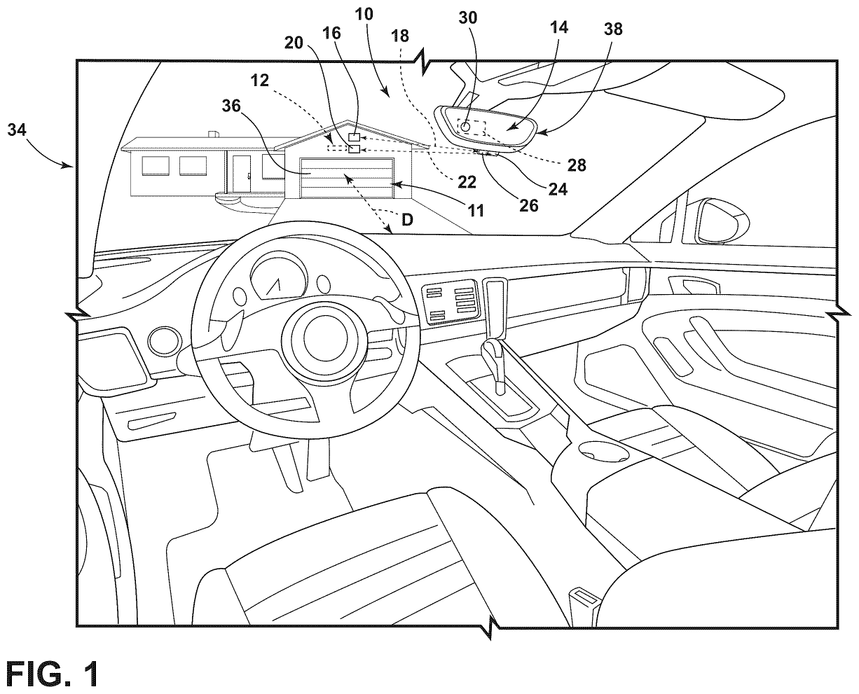

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-4, reference numeral 10 generally designates a door operating system that moves a door 11 between a closed position and an open position. The door operating system 10 includes a door opening mechanism 12 and a user controller 14. The door opening mechanism 12 includes a first receiver 16 configured to receive a short range signal (e.g., a radio frequency or RF signal 18) and a second receiver 20 configured to receive an internet signal 22. The user controller 14 is in operable communication with the door opening mechanism 12 and includes a short range transmitter (e.g., an RF transmitter 24) capable of transmitting the RF signal 18 to the door opening mechanism 12 and a wireless internet transmitter 26 that is capable of transmitting the internet signal 22 to the door opening mechanism 12. The user controller 14 further includes a user interface 28 including at least one user input element 30. A control system 100 (e.g., a processor 104) is in operable communication with the door opening mechanism 12 and the user controller 14. The control system 100 is configured to receive an input from the user controller 14 to open or close the door 11 and determine if the RF signal 18 from the RF transmitter 24 will be received by the door opening mechanism 12.

With continued reference to FIGS. 1-4, the control system 100 (e.g., the processor 104) may be further configured to, upon a determination that the RF signal 18 will not be received by the door opening mechanism 12, cause the wireless internet transmitter 26 to transmit the internet signal 22 to the door opening mechanism 12. For example, the control system 100 may be configured to determine if the RF signal 18 from the RF transmitter 24 will be received by the door opening mechanism 12 by causing the RF transmitter 24 to transmit the RF signal 18 to the door opening mechanism 12 and determining if the RF signal 18 has been received by the door opening mechanism 12. In other words, the RF transmitter 24 may automatically transmit the RF signal 18 to the door opening mechanism 12 to determine if there is connectivity between the RF transmitter 24 and the door opening mechanism 12, which may include one or more of receiving the RF signal 18 that is continuously being sent to the door 11, sending and receiving an echo signal (e.g., of the RF signal) back from the door 11, sending a control signal and receiving a status information (e.g., via an internet signal) back over the internet (e.g., command “open” and status information says the door is opening). In some embodiments, the control system 100 may use other methodologies to determine connectivity. For example, the control system 100 may be configured to determine if the RF signal 18 from the RF transmitter 24 will be received by the door opening mechanism 12 by determining a proximity of the door opening mechanism 12 to the user controller 14. More particularly, the door operating system 10 may include and/or work in conjunction with a global positioning system 32 (“GPS”) that triangulates a distance “D” between the RF transmitter 24 and the door opening mechanism 12. When the distance D is greater than a predetermined threshold outside of a range of the RF signal 18, the door operating system 10 may default to operating with the internet signal 22.

With reference now specifically to FIG. 1, the door 11 may be configured to be operable in a variety of environments. For example, the door 11 may be configured to allow access to a vehicle, such as an automobile 34. More particularly, the door 11 may be a garage door as illustrated in FIG. 1. However, it should be appreciated that the door 11 could be configured for an aircraft hangar, a boat shed, a door to a gate, and/or the like. The door 11 may include a series of panels 36 that are rolled as the door 11 is opened and unrolled as the door 11 is closed. In some embodiments, however, the door 11 may be a sliding door, a folding door, and/or the like. The user controller 14 may likewise have a variety of configurations. For example, the user controller 14 may be integral with a structure of the automobile (e.g., the vehicle 34, a water vessel (e.g., boat), an airplane, and/or the like), such as an infotainment center, a heads-up display, a control panel, or a rearview mirror 38 (e.g., a full display rearview mirror, a rearview mirror with an electro-optic element, and/or the like). In other embodiments, the user controller 14 may be located on a portable device, such as a remote, a fob, a mobile phone, and/or the like. The user input element 30 may be located on the user controller 14 (e.g., as a button or switch) or, alternatively, be located on a paired device (e.g., via a mobile application), such as a phone or control panel in the vehicle and send instructions to the user controller 14 via, for example, wireless transmission. In some embodiments, the user controller 14 may include a status indicator 39 (e.g., a display, a light, and/or the like) that notifies the user if the door 11 is in the open position, the closed position, or an intermediate position.

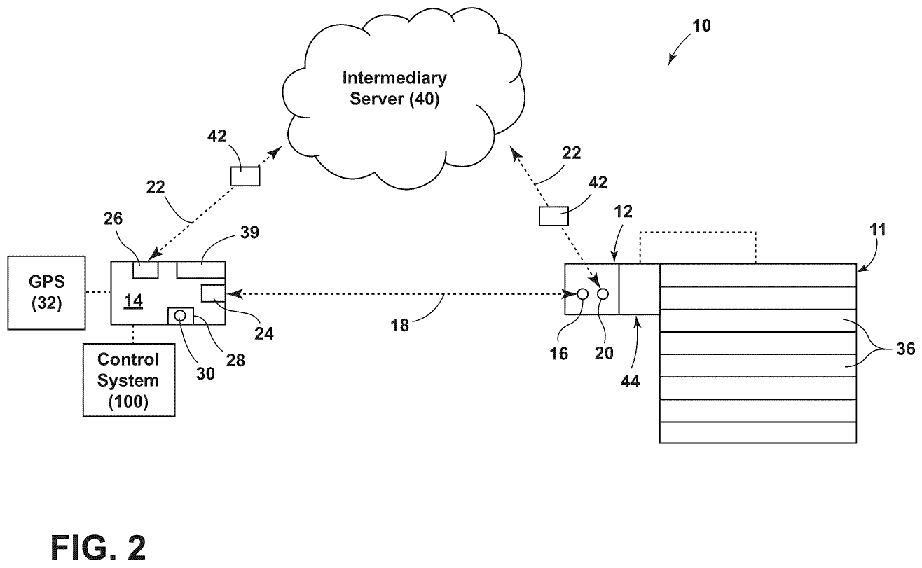

With reference now to FIG. 2, the door opening mechanism 12 may be a mechanical device, such as a chain-driven device, a belt-driven device, a screw-driven device, a gear-driven device, and/or the like that moves, slides, rolls, and/or otherwise articulates the door 11 between the closed position and the open position. The user controller 14 and the door opening mechanism 12 are connected to the internet (e.g., through a router, cellular networks, and/or the like). In some embodiments, the user controller 14 and the door opening mechanism 12 are selectively connected to the internet through the router or cellular networks based on user preferences and/or router availability. In this manner, the internet signal 22 may be a WIFI signal, a cellular signal, and/or the like. An intermediary server 40, such as a cloud with database storage and an application programming interface (API) may be in communication to the user controller 14 and the door opening mechanism 12 via the internet. As such, the user controller 14 may transmit the internet signal 22 initially to the intermediary server 40 for signal recognition/certification whereafter the internet signal 22 is transmitted to the door opening mechanism 12.

With continued reference to FIG. 2, the door operating system 10 (e.g., the control system 100) may be configured to operate with the RF transmitter 24 and the first receiver 16 by default. In this manner, bandwidth can be conserved and a more reliable communication path can be conserved. Thus, in some embodiments, only upon a determination that the RF signal 18 will not be received by the door opening mechanism 12, will the door operating system 10 operate with the internet signal 22. Further, the door operating system 10 can operate without internet connectivity when the internet is down. The two-pathway approach (i.e., selectively operable with both the RF signal and the internet signal 22) effectively ensures that the door 11 can be opened and closed in a variety of scenarios. As will be described in greater detail below, the door opening mechanism 12 and the user controller 14 are initially paired. During the pairing, a key 42 (e.g., an identifier) may be generated and saved in the intermediary server 40 with a specific API without requiring additional registration or login information. Thus, in some embodiments, the internet signal 22 may include the key 42, which is authenticated by the intermediary server 40. It is contemplated that the short range signal from the short range transmitter (e.g., an RF transmitter 24) may include the RF signal 18 or include other types of short range signals (e.g., Bluetooth, NearLink, near-field communication (NFC), LPWAN, ultra-wideband (UWB) and IEEE 802.15.) and short range transmitter (e.g., an RF transmitter 24).

The door opening mechanism 12 may include a mechanical device (not shown) that mechanically moves the door 11 between the open and closed position. The mechanical device may include a gear-driven system, a pulley system, combinations thereof, or any other form of device that can be utilized to open and close the door 11. The door opening mechanism 12 (e.g., the mechanical device) may be in operable communication with both the first receiver 16 and the second receiver 20. In some embodiments, the control system 100 (e.g., the door opening mechanism 12) includes a door control system 44 that receives the signals from the first receiver 16 and the second receiver 20, authenticates the key 42, and, in response to the key being authenticated, causes the door 11 to open and/or close. The door control system 44 may include one or more microprocessors, microcontrollers, application-specific integrated circuits (ASIC), or other circuitry configured to perform instructions, computations, and control various input/output signals to the door opening mechanism 12.

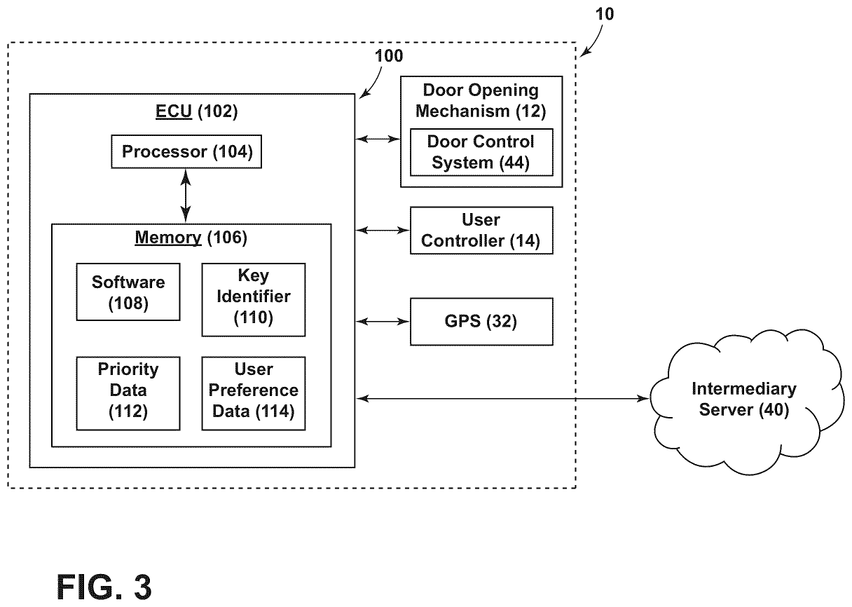

With reference now to FIG. 3, the control system 100 of door operating system 10 is illustrated. The control system 100 may include an electronic control unit (ECU) 102 configured to perform the functions and method steps as described herein. The ECU 102 may include the processor 104 and a memory 106. The processor 104 may include any suitable processor. Additionally, or alternatively, the ECU 102 may include any suitable number of processors, in addition to or other than the processor 104. The memory 106 may comprise a single disk or a plurality of disks (e.g., hard drives), and includes a storage management module that manages one or more partitions within the memory 106. In some embodiments, the memory 106 may include flash memory, semiconductor (solid state) memory, or the like. The memory 106 may include Random Access Memory (RAM), a Read-Only Memory (ROM), or a combination thereof. The memory 106 may include instructions that, when executed by the processor 104, cause the processor 104 to, at least, perform the functions and method steps as described herein. The door opening mechanism 12, the user controller 14, and the global positioning system (GPS) 32 may therefore be controlled, receive inputs, and/or transmit inputs to and from the ECU 102 and intermediary server 40. The ECU 102 may receive and/or the memory 106 may save software 108, key identifier 110 (e.g., relating to the key 42 for authentication), priority data 112 (e.g., the method of prioritizing operation with the RF signal 18 or the internet signal 22), and user preference data 114 (e.g., if a particular driver would rather initially default to operation with the internet signal 22).

The software 108 may include instructions for initially pairing the door opening mechanism 12 to the user controller 14. For example, the software may include or otherwise generate the key 42. Once the key 42 is generated and authenticated between the door opening mechanism 12 to the user controller 14, software 108 may include instructions to transmit (e.g., automatically) the key 42 to intermediate server 40. The key 42 transmitted by the RF signal 18 and the internet signal 22 may be the same. In some embodiments, the software 108 may include instructions to transform the key 42 before transmission to the intermediate server 40 such that the key 42 transmitted by the RF signal 18 and the internet signal 22 is different. The software 108 may further include instructions for the API (e.g., generating the API on the user controller 14). The software 108 may further include instructions for the control system 100 to authenticate the key 42 prior to operating the door opening mechanism 12.

The key identifier 110 (e.g., instructions relating to the key 42 for authentication), may include instructions for comparing authentication from the control system 100 to the key 42 that has been transmitted. The key identifier 110 may be located in the memory 106, the door control system 44, the intermediate server 40, and/or combinations thereof.

The priority data 112 (e.g., instructions relating to the method of prioritizing operation with the RF signal 18 or the internet signal 22), may include instructions to initially operate under the principles of the RF signal 18. If the RF signal 18 is not received, as previously described, the priority data 112 may include instructions to generate the internet signal 22. In some embodiments, the priority data 112 may include instructions to detect and diagnose problems related to the transmitting and receiving the RF signal 18 or internet signal 22. For example, if the door operating system 10 does not successfully transmit and/or receive the RF signal 18, the priority data 112 may include instructions to determine if the RF signal 18 should have been received. For example, the user controller 14 is within a predetermined distance where the short range signal (e.g., RF signal 18) is expected to be received by the door opening mechanism 12, the priority data 112 may include instructions to determine if the short range signal was received by the door opening mechanism 12 to diagnose if the door operating system 10 is experiencing problems with transmission, receipt, or authentication of the key 42. Likewise, if the door operating system 10 does not successfully transmit and/or receive the internet signal 22, the priority data 112 may include instructions to, when the user controller 14 is within the predetermined distance, determine if the RF signal 18 is transmitted and received successfully. If the RF signal 18 is received, the diagnosis may include that the second receiver 20 or the wireless internet transmitter 26 is experiencing problems and the key 42 needs to be re-authenticated (e.g., via repeating the initial process) or otherwise needs servicing. When the RF signal 18 and/or internet signal 22 is successfully received and transmitted, the priority data 112 may include instructions to diagnose that the door opening mechanism 12 (e.g., the mechanical device) is experiencing problems and needs servicing. The diagnosis may be generated on the user controller 14 (e.g., the status indicator 39) or otherwise transmitted to a user (e.g., via the API).

The user preference data 114 may include options for the user. For example, the user may prefer initially defaulting to the internet signal 22 before generating the RF signal. Likewise, the user preference data 114 may include instructions to generate notifications to a user if, for example, the control system 100 receives instructions to transmit the RF signal 18 and/or internet signal 22 and the user controller 14 is outside of remoteness threshold indicating inadvertent usage. The notification may initially prevent transmission of the RF signal 18 or internet signal 22 and include an option to override.

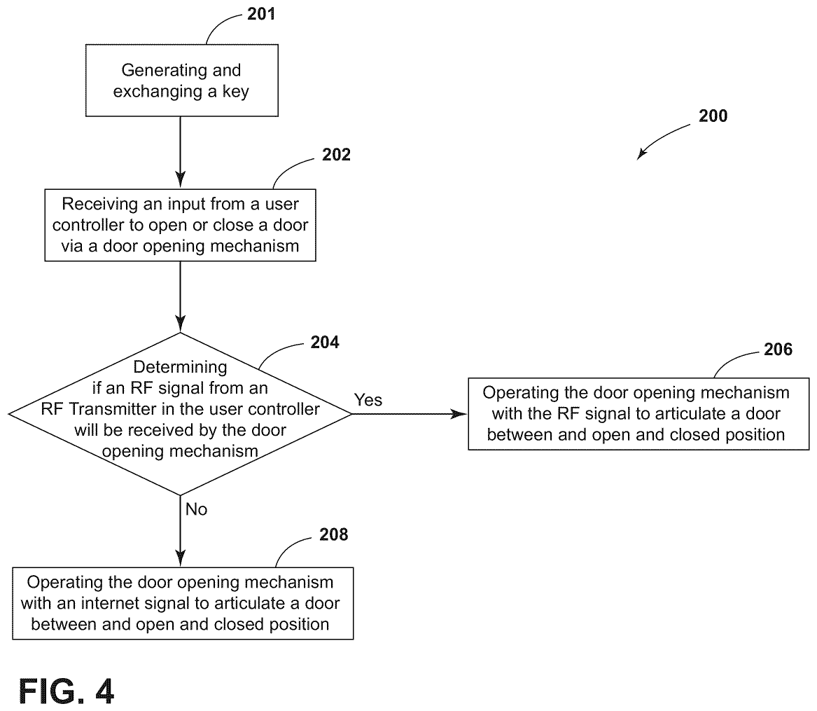

FIG. 4 illustrates a method 200 of utilizing a door operating system that includes a dual authentication process. At step 201, the method 200 includes generating and exchanging a key. For example, step 201 may include generating and/or exchanging the key during the initial remote-to-door pairing process and subsequently storing the key in a memory such as a non-volatile memory (“NVM”). Step 201 may further include a training process of the door operating system where the key can be utilized for an internet path as it is exchanged. More particularly, the step 201 may include transmitting an internet signal that includes the key to an intermediary server where the key is authenticated and saved. Step 201 may further include accessing the memory as an authentication mechanism when an internet signal is used (i.e., an API endpoint is called using this key as the authentication). This bi-modal training gives the door operating system the function to securely control the garage door via an RF signal or the internet signal.

With continued reference to FIG. 4, at step 202, the method 200 includes receiving an input from a user controller to open or close a door via a door opening mechanism (e.g., via actuation of a button or switch). At step 204, the method 200 includes determining if the RF signal from an RF transmitter in the user controller will be received by the door opening mechanism. For example, step 204 may include determining if the RF signal from the RF transmitter will be received by the door opening mechanism by causing the RF transmitter to transmit the RF signal to the door opening mechanism and determining if the RF signal has been received by the door opening mechanism. In other embodiments, step 204 may utilize other methodologies to determine connectivity. For example, step 204 may include determining if the RF signal from the RF transmitter will be received by the door opening mechanism by determining a proximity of the door opening mechanism to the user controller. In other examples, step 204 may include one or more of receiving the RF signal that is continuously being sent by the garage door, or sending and receiving an echo signal (e.g., of the RF signal) back from the garage, or sending a control signal and receiving a status information (e.g., via an internet signal) back over the internet (e.g., command “open” and the status information says the door is opening).

At step 206, if the determination concludes that the RF signal will be received by the door opening mechanism, the method 200 may include operating the door opening mechanism with the RF signal to articulate a door between an open and closed position (or any intermediate positions). At step 208, if the determination concludes that the RF signal will not be received by the door opening mechanism, the method 200 may include operating the door opening mechanism with the internet signal to articulate a door between an open and closed position (or any intermediate positions). Step 208 may include authenticating the key, for example, at the intermediate server.

The disclosure herein is further summarized in the following paragraphs and is further characterized by combinations of any and all of the various aspects described therein.

According to one aspect of the present disclosure, a door operating system that moves a door between a closed position and an open position is provided. The door operating system includes a door opening mechanism and a user controller. The door opening mechanism includes a first receiver configured to receive an RF signal and a second receiver configured to receive an internet signal. The user controller is in operable communication with the door opening mechanism and includes an RF transmitter capable of transmitting the RF signal to the door opening mechanism and a wireless internet transmitter that is capable of transmitting the internet signal to the door opening mechanism. The user controller further includes a user interface including at least one user input element. A control system is in operable communication with the door opening mechanism and the user controller. The control system is configured to generate and exchange a key during an initial pairing, receive an input from the user controller to open or close a door, and determine if the RF signal from the RF transmitter will be received by the door opening mechanism.

According to another aspect, a control system is configured to, upon a determination that an RF signal will not be received by a door opening mechanism, cause a wireless internet transmitter to transmit an internet signal to the door opening mechanism.

According to yet another aspect, the control system is configured to determine if the RF signal from the RF transmitter will be received by the door opening mechanism by causing the RF transmitter to transmit the RF signal to the door opening mechanism and determining if the RF signal has been received by the door opening mechanism.

According to another aspect, the control system is configured to determine if the RF signal has been received by the door opening mechanism by sending and receiving an echo signal.

According to yet another aspect, the control system is configured to determine if the RF signal has been received by the door opening mechanism by receiving status information to a user controller.

According to another aspect, the status information is received over the internet.

According to still yet another aspect, the control system is configured to determine if the RF signal from the RF transmitter will be received by the door opening mechanism by determining a proximity of the door opening mechanism to the user controller.

According to another aspect, the control system is configured to authenticate the key prior to operating the door opening mechanism.

According to yet another aspect, a control system is further configured to automatically transmit a key to an intermediary server during an initial pairing with a door opening mechanism.

According to another aspect, a wireless internet transmitter is configured to transmit an internet signal to the door opening mechanism through the intermediary server.

According to another aspect of the present disclosure, a door operating system that moves a door between a closed position and an open position is provided. The door operating system includes a door opening mechanism and a user controller. The door opening mechanism includes a first receiver configured to receive a short range signal and a second receiver configured to receive an internet signal. A user controller is in operable communication with the door opening mechanism. The user controller includes a short range transmitter capable of transmitting the short range signal to the door opening mechanism, a wireless internet transmitter capable of transmitting the internet signal to the door opening mechanism, and a user interface including at least one user input element. A control system is in operable communication with the door opening mechanism and the user controller. The control system is configured to generate the short range signal and exchange a key during an initial pairing, generate the internet signal and transfer the key to an intermediary server, and selectively transmit at least one of the short range signal and the internet signal to move the door between the open position and the closed position.

According to another aspect, a control system is further configured, upon a request from a user controller to move a door, initially transmit a short range signal from a short range transmitter to a door opening mechanism, and determine if the short range signal from the short range transmitter has been received by the door opening mechanism. If the short range signal has not been received by the door opening mechanism, the control system is further configured to transmit the internet signal from the wireless internet transmitter to the door opening mechanism.

According to yet another aspect, the short range signal is an RF signal.

According to another aspect, the door is a garage door and the user controller is at least partially located in a rearview mirror.

According to still yet another aspect, the door is a gate door and the user controller is associated with at least one of a vehicle, airplane, or a water vessel.

According to yet another aspect of the present disclosure, a door operating system that moves a door between a closed position and an open position is provided. The door operating system includes a door opening mechanism and a user controller. The door opening mechanism includes a first receiver configured to receive a short range signal and a second receiver configured to receive an internet signal. A user controller is in operable communication with the door opening mechanism. The user controller includes a short range transmitter capable of transmitting the short range signal to the door opening mechanism, a wireless internet transmitter capable of transmitting the internet signal to the door opening mechanism, and a user interface including at least one user input element. A control system is in operable communication with the door opening mechanism and the user controller. The control system is configured to initially transmit the short range signal from the short range transmitter to the door opening mechanism, and determine if the short range signal from the short range transmitter has been or will be received by the door opening mechanism. If the short range signal has not been received by the door opening mechanism, the control system is further configured to transmit the internet signal from the wireless internet transmitter to the door opening mechanism.

According to another aspect, a control system is configured to initially pair a user controller to a door opening mechanism by generating a short range signal and exchanging a key during an initial pairing, and generating an internet signal and transferring the key to an intermediary server.

According to yet another aspect, the short range signal is an RF signal.

According to another aspect, a control system is configured to determine if a short range signal from a short range transmitter has been received by a door opening mechanism by sending and receiving an echo signal.

According to still yet another aspect, a control system is configured to determine if a short range signal from a short range transmitter will be received by determining a proximity of a door opening mechanism to a user controller.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A door operating system to move a door between a closed position and an open position, the door operating system comprising:
a door opening mechanism including a first receiver configured to receive an RF signal and a second receiver configured to receive an internet signal;
a user controller in operable communication with the door opening mechanism, the user controller comprising:
an RF transmitter capable of transmitting the RF signal to the door opening mechanism;
a wireless internet transmitter capable of transmitting the internet signal to the door opening mechanism; and
a user interface including at least one user input element;
a control system in operable communication with the door opening mechanism and the user controller, the control system configured to:
generate and exchange a key during an initial pairing;
receive an input from the user controller to open or close the door; and
determine if the RF signal from the RF transmitter will be received by the door opening mechanism.

2. The door operating system of claim 1, wherein the control system is further configured to, upon a determination that the RF signal will not be received by the door opening mechanism, cause the wireless internet transmitter to transmit the internet signal to the door opening mechanism.

3. The door operating system of claim 2, wherein the control system is configured to determine if the RF signal from the RF transmitter will be received by the door opening mechanism by causing the RF transmitter to transmit the RF signal to the door opening mechanism and determining if the RF signal has been received by the door opening mechanism.

4. The door operating system of claim 3, wherein the control system is configured to determine if the RF signal has been received by the door opening mechanism by sending and receiving an echo signal.

5. The door operating system of claim 3, wherein the control system is configured to determine if the RF signal has been received by the door opening mechanism by receiving status information to the user controller.

6. The door operating system of claim 5, wherein the status information is received over the internet.

7. The door operating system of claim 2, wherein the control system is configured to determine if the RF signal from the RF transmitter will be received by the door opening mechanism by determining a proximity of the door opening mechanism to the user controller.

8. The door operating system of claim 2, wherein the control system is configured to authenticate the key prior to operating the door opening mechanism.

9. The door operating system of claim 1, wherein the control system is further configured to automatically transmit the key to an intermediary server during the initial pairing.

10. The door operating system of claim 9, wherein the wireless internet transmitter is configured to transmit the internet signal to the door opening mechanism through the intermediary server.

11. A door operating system to move a door between a closed position and an open position, the door operating system comprising:
a door opening mechanism including a first receiver configured to receive a short range signal and a second receiver configured to receive an internet signal;
a user controller in operable communication with the door opening mechanism, the user controller comprising:
a short range transmitter capable of transmitting the short range signal to the door opening mechanism;
a wireless internet transmitter capable of transmitting the internet signal to the door opening mechanism; and
a user interface including at least one user input element;
a control system in operable communication with the door opening mechanism and the user controller, the control system configured to:
generate the short range signal and exchange a key during an initial pairing;
generate the internet signal and transfer the key to an intermediary server; and
selectively transmit at least one of the short range signal and the internet signal to move the door between the open position and the closed position.

12. The door operating system of claim 11, wherein the control system is further configured, upon a request from the user controller to move the door, to:
initially transmit the short range signal from the short range transmitter to the door opening mechanism;
determine if the short range signal from the short range transmitter has been received by the door opening mechanism; and
if the short range signal has not been received by the door opening mechanism, transmit the internet signal from the wireless internet transmitter to the door opening mechanism.

13. The door operating system of claim 11, wherein the short range signal is an RF signal.

14. The door operating system of claim 11, wherein the door is a garage door and the user controller is at least partially located in a rearview mirror.

15. The door operating system of claim 11, wherein the door is a gate door and the user controller is associated with at least one of a vehicle, airplane, or a water vessel.

16. A door operating system to move a door between a closed position and an open position, the door operating system comprising:
a door opening mechanism including a first receiver configured to receive a short range signal and a second receiver configured to receive an internet signal;
a user controller in operable communication with the door opening mechanism, the user controller comprising:
a short range transmitter capable of transmitting the short range signal to the door opening mechanism;
a wireless internet transmitter capable of transmitting the internet signal to the door opening mechanism; and
a user interface including at least one user input element;
a control system in operable communication with the door opening mechanism and the user controller, the control system configured to:
initially transmit the short range signal from the short range transmitter to the door opening mechanism;
determine if the short range signal from the short range transmitter has been or will be received by the door opening mechanism; and
if the short range signal has not been received by the door opening mechanism, transmit the internet signal from the wireless internet transmitter to the door opening mechanism.

17. The door operating system of claim 16, wherein the control system is further configured to initially pair the user controller to the door opening mechanism, including:
generating the short range signal and exchanging a key during an initial pairing; and
generating the internet signal and transferring the key to an intermediary server.

18. The door operating system of claim 16, wherein the short range signal is an RF signal.

19. The door operating system of claim 16, wherein the control system is configured to determine if the short range signal from the short range transmitter has been received by the door opening mechanism by sending and receiving an echo signal.

20. The door operating system of claim 16, wherein the control system is configured to determine if the short range signal from the short range transmitter will be received by determining a proximity of the door opening mechanism to the user controller.
